(19) United States
(12) Patent Application Publication
(10) Pub. No.: US 2026/0097792 A1
(43) Pub. Date: Apr. 9, 2026

(54) COUNTERACTING IMPACTS OF WIND CONDITIONS ON A MOVING VEHICLE

(71) Applicant: Intel Corporation, Santa Clara, CA (US)

(72) Inventors: Robert L. VAUGHN, Portland, OR (US); Cornelius BUERKLE, Karlsruhe (DE); Fabian OBORIL, Karlsruhe (DE)

(21) Appl. No.: 19/417,401

(22) Filed: Dec. 12, 2025

Related U.S. Application Data
(60) Provisional application No. 63/831,204, filed on Jun. 27, 2025.

(51) Int. Cl. B60W 60/00; B60W 40/02

(52) U.S. Cl. CPC B60W 60/00182; B60W 40/02; B60W 2300/145; B60W 2555/20

(57) ABSTRACT

Disclosed herein are systems, devices, and apparatuses for counteracting in real-time the safety and aerodynamic impacts of wind conditions on a moving vehicle. The device determines a wind condition acting on a vehicle that is in motion and, based on the wind condition, determines an adjustment to a steering parameter of the vehicle or to a surface geometry of the vehicle that is exposed to the wind condition. The device then controls the vehicle to change the steering parameter or the surface geometry based on the adjustment.

### CROSS-REFERENCE TO RELATED APPLICATION(S)

This application claims priority to U.S. Provisional Application No. 63/831,204, filed on Jun. 27, 2025, the entire contents of which are incorporated herein by reference.

### BACKGROUND

Wind conditions may impact the safety and aerodynamic efficiency of a moving vehicle. Strong winds and wind gusts, for example, may cause vehicles-especially vehicles like semitrucks—to drive erratically, stop suddenly, jackknife, or lose their load, all of which present safety hazards to the vehicle and other vehicles in its vicinity. If the aerodynamics of a vehicle are such that it is not safe for the vehicle to drive in such wind conditions, the vehicle may need to stop or slow down until the wind conditions improve, possibly negatively impacting the effective transport of goods or the free movement of people. In addition, even if wind conditions are such that they do not rise to the level of a safety hazard, the wind conditions may impact the aerodynamic efficiency of the vehicle. For example, unfavorable wind conditions may create excessive drag on the vehicle, causing it to slow down or requiring more engine energy to overcome the drag. While static solutions such as spoilers, fairing or contouring components, air dams, deflectors, etc. may exist for improving aerodynamics in a vehicle, these fail to address the variability in wind conditions experienced by moving vehicles.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of an adaptive wind-based controller system that may adaptively control a vehicle based on current wind conditions;

FIG. 2 illustrates an example of proactively determining adjustments to the orientation of the cargo/load based on the actual or predicted heading of the vehicle and the corresponding wind conditions that result;

FIG. 3 depicts an example of a trailer fitted with multiple pallets/containers, each of which may be rotated dynamically based on the wind conditions;

FIG. 4 shows a graph for the amount of force acting on a vehicle due to various crosswinds (e.g., drag);

FIG. 5 shows different example views of how the arrangement of unbalanced pallets within a trailer might be adapted based on the wind conditions so as to rebalance the trailer;

FIG. 6 shows example views of another option for real-time wind-based adjustments, where the load may be dynamically lifted to create space under the load;

FIG. 7 illustrates example views of another option for real-time wind-based adjustments, where the aerodynamics (e.g., shape/height of trailer) may be dynamically adjusted based on the wind conditions;

FIG. 8 illustrates example views of how a crosswind acting on a trailer may misalign the trailer with respect to its ground heading, and how the adaptive wind-based controller system may correct this misalignment; and

FIG. 9 depicts a cross-sectional view of a semitruck trailer that has been annotated with information related to the various forces at play with respect to a potential rollover from a strong crosswind; and

FIG. 10 depicts an exemplary schematic flow diagram of a method for adapting the steering, aerodynamics, or load position of a vehicle based on the wind conditions to improve safety and efficiency.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of machinery that may be operated by software, including autonomous, partially autonomous, stationary, moving, or other objects or entities that utilize software as part of their operation. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a robot, a personal transporter, a boat, a ship, a submersible, a submarine, a drone, an aircraft, industrial machinery, autonomous or partially autonomous machinery, or a rocket, among others.

As noted above, wind conditions may have a significant impact on vehicle safety and aerodynamic efficiency. Strong winds or wind gusts may be a threat to large vehicles—in particular large trucks. According to the National Highway Traffic Safety Administration (NHTSA), in 2016, there were over 1,000 large truck crashes as a result of severe crosswinds. Indeed, common truck accidents caused by strong winds or wind gusts may include a truck rollover, a jackknife accident, an under ride collision, or a lost load accident, just to name a few. In a truck rollover—the most common type of accident—the driver may lose control of the truck or if the truck carries too light of a load, the truck can slide and roll over on its side. In a jackknife accident, a trailer towed by the vehicle approaches a 90-degree angle with respect to the towing vehicle (e.g., the front part of the semitruck or “cab”). During a high wind, the driver might try to brake too hard or too quickly which may result in a jackknife accident.

An under ride collision is one of the deadliest type of accidents, where the truck may quickly stop due to the driver trying to regain control of the truck that has been moved the strong wind. If a following vehicle is too close to the truck or if the driver of the following vehicle is not paying attention, the following vehicle could end up colliding with and become lodged underneath the trailer. A lost load accident is where cargo (or the “load”) of a vehicle comes detached from the vehicle/trailer. For example, if cargo is not sufficiently secured to handle a strong wind, the cargo could fly off the vehicle and creating a sudden impact hazard for other vehicles, which may result in a chain reaction of collision hazards in the form of other vehicles swerving quickly out of the way, itself a safety hazard.

Semitrucks (also referred to as “semis,” “trucks,” or “tractor-trailers”) may be particularly susceptible to winds due to the large surface areas created by the trailers, leading to a sail effect. In an attempt to avoid wind-related accidents, a truck driver may slow down, come to a complete stop, or add/remove cargo to ensure a recommended trailer loading. As should be understood, these solutions may have an economic impact, especially in the transport industry, where it may take longer or be more expensive to deliver goods, reposition trucks, or pick up shipments. In the United States, it is common in the transport sector that trucks must slow down or stop due to high wind speeds. While semitrucks provide a particular relevant example as to the safety and economic impact caused by wind conditions, same physical aspects and restrictions may apply also be seen in the examples of other vehicles such as trains and ships, just to name a few.

Wind conditions may also impact the energy demand of the vehicle (and thus the associated cost of fuel that provide the energy, be it solar, fossil, hydrogen, etc.). Wind conditions may create aerodynamic forces that act upon a vehicle in motion (e.g. including trucks, trains, ships, etc.), and thus these aerodynamic forces may be a primary variable that is determinative of energy consumption requirements, when other factors are equal (e.g., speed, acceleration, load, travel distance, etc.). With respect to vehicle aerodynamics, the surface area presented to the oncoming air flow may be one of the primary factors in determining the impact to the vehicle (e.g., drag). While great advances have been made on improving aerodynamics of vehicles, those advances are primarily related to the static shape of the vehicle that provides a linear wind flow with a low aerodynamic drag.

Unlike those solutions, disclosed herein is an adaptive wind-based control of a vehicle's steering, surface geometry, or load placement that may react in real-time to the current wind conditions experienced by the vehicle while it is in motion. By adjusting the vehicle's steering profile, surface geometry, or load placement in response to the current wind conditions (e.g., the wind's angle of attack and or speed incident to the surfaces of the vehicle), the aerodynamic drag caused by the wind conditions—and risk of accident therefrom—may be significantly reduced. For example, the surface geometry may be adjusted in such a manner so as to reduce the overall surface area of the vehicle presented to the direction of the oncoming airflow. One example of such wind-based adaptive control is to adjust the orientation of a vehicle, its load, or its containers so that the surface area exposed to the oncoming wind is reduced. As another example, the steering may be adjusted to counteract destabilizing wind forces (e.g., a wind sheer) or to take advantage of advantageous wind forces (e.g., a tailwind). Another example of wind-based adaptive control is to adjust the center of gravity of the vehicle (e.g., by adjusting the placement of the cargo in the vehicle) to counteract the destabilizing torque caused by the incident wind forces. As should be appreciated from the description below, wind-based adaptive control may improve safety of the vehicle due to its ability to react to variable wind conditions and may also improve the energy demand (e.g., due to drag cause by the wind and reduction of that drag by making wind-based adjustments). More details of the adaptive wind-based controller are discussed below.

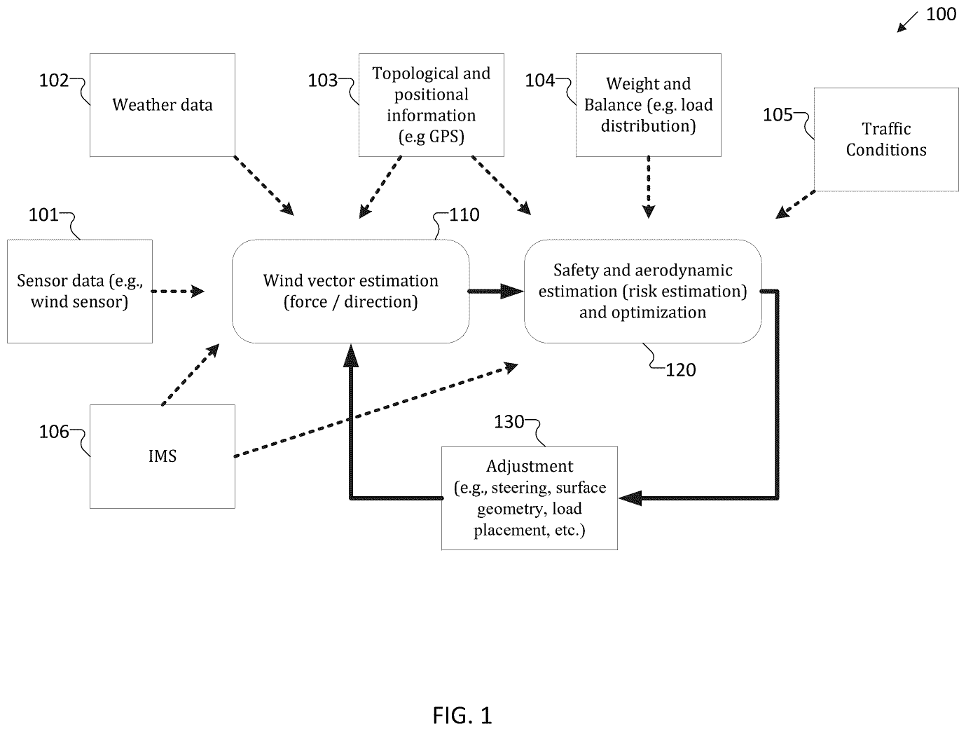

FIG. 1 shows an example of an adaptive wind-based controller system 100 that may adaptively control a vehicle (e.g., its steering, surface geometry, load placement, etc.) based on current wind conditions so as to improve the safety and/or efficiency of the vehicle with respect to the wind. The adaptive wind-based controller system 100 may estimate a wind vector (e.g., an angle of incidence on the vehicle and its magnitude (e.g., velocity)) based on any number of relevant informational sources such as from sensor data 101 (e.g. a wind sensor), weather data 102, topological (e.g., map data) and positional (e.g., global positioning system (GPS) data) information 103, inertial measurement system (IMS) 106, etc. As should be understood, this example list is non-exhaustive and the wind-based controller system 100 may take into account any number of factors and information to estimate wind vectors and other wind-related information.

The adaptive wind-based controller system 100 may then, based on the wind vector(s) and other wind-related information, determine adjustments to the vehicle (e.g., its steering, surface geometry, load placement, etc.) based on how the wind may impact the safety and or aerodynamics of the vehicle (e.g., in order to optimize safety, efficiency, etc.). As should be understood, any type of rules-based or machine learning model may be used for determining the adjustment based on the current wind conditions and according to the safety/efficiency goals of the vehicle. As should be understood, any number of factors may be considered as part of the adjustment determination, including factors such as current or predicted traffic conditions 105, current or predicted weight and balance conditions 104 (e.g., load distribution), the inertial measurement system (IMS) 106, etc. Next the vehicle is instructed, in 130, to make the determined adjustment(s). As should be understood, this may be a continuous process that adapts in real-time to the changing conditions of the vehicle.

One example of an adaptive wind-based controller is one that is configured to changes the orientation of the cargo (e.g., the load) of the vehicle. For example, in the case where the vehicle is a tractor-trailer, the adaptive wind-based controller may use rules that have goals of optimizing aerodynamic stability of the trailer. The adaptive wind-based controller may do this by adjusting the orientation of the cargo so as to minimize the impact of crosswinds incident on the load/cargo. For example, rather than traditional enclosed trailers (e.g., a box-like structure such as a shipping container, that present a large, flat surface to lateral winds, leading to increased drag, potential lane deviation, and rollover risks), the trailer may be an open-air flatbed where independently rotating and aerodynamic containers may be mounted on the flatbed. The adaptive wind-based controller may determine orientations for rotating these containers dynamically so as to reduce the cross-sectional area exposed to crosswinds. This dynamic adaption may improve the overall safety and efficiency of the vehicle, given the current wind conditions.

With respect to the wind vector estimation 110, adaptive wind-based controller system 100 may estimate the strength and orientation of the wind. As noted, any amount of externally-obtained information may be used such as weather data 102, topological and positional information 103, sensor data 101, etc. Such information may be fused to enhance the estimation. Wind vector estimation 110 may use, alternatively or in addition, information obtained from internal sensors. In the example of a semitruck, it may have load sensors on each wheel, for example, which may be used to detect strong winds because the wind may lift one side of the trailer, registering in the load sensors. Using information about vehicle speed (e.g., from an internal or external IMS 106), surface area of the vehicle, and power consumption, the wind vector estimation 110 may estimate the force of the wind incident the truck.

With respect to the safety and aerodynamic estimation 120, this may estimate a safety risk to the vehicle associated with the wind forces. It may also determine adjustments as countermeasures to lower risk. For example, the risk that the vehicle may tip over may be estimated based on the wind angle, wind velocity, air temperature, surface area of the vehicle (along with its trailer and other exposed contents), the weight of the vehicle, and the velocity of the vehicle. While some of these values may be fixed values (or change relatively slowly compared to the wind vector), some values may be adjustable, including, for example, surface area (e.g., modifiable by the orientation or shape of the load) and the velocity of the vehicle (e.g., modifiable by speed control or steering). The safety and aerodynamic estimation 120 may optimize the adjustable parameters to ensure that the risk (e.g., an estimation thereof) satisfies a predefined criterion (e.g., stays within a predetermined range or at a predetermined level). For example, the safety and aerodynamic estimation 120 may determine an optimal orientation/shape of the load for a given maximal allowed velocity. As explained with more detailed examples below, safety and aerodynamic estimation 120 may calculate the wind force for any number of different surfaces.

As should be understood, the safety and aerodynamic estimation 120 may utilize rules in order to account and tradeoff among the various optimization goals. For example, surface area and efficiency/performance may have tradeoffs, where, for example, rotating the cargo load may change the drag of the vehicle and increase the energy consumption of the vehicle to counteract an increase in drag or reduce energy consumption if the drag is reduced. Thus, the rules may be parameterized (e.g., weighted or prioritized by a configuration from the user to) in order to provide a mechanism for resolving such tradeoffs.

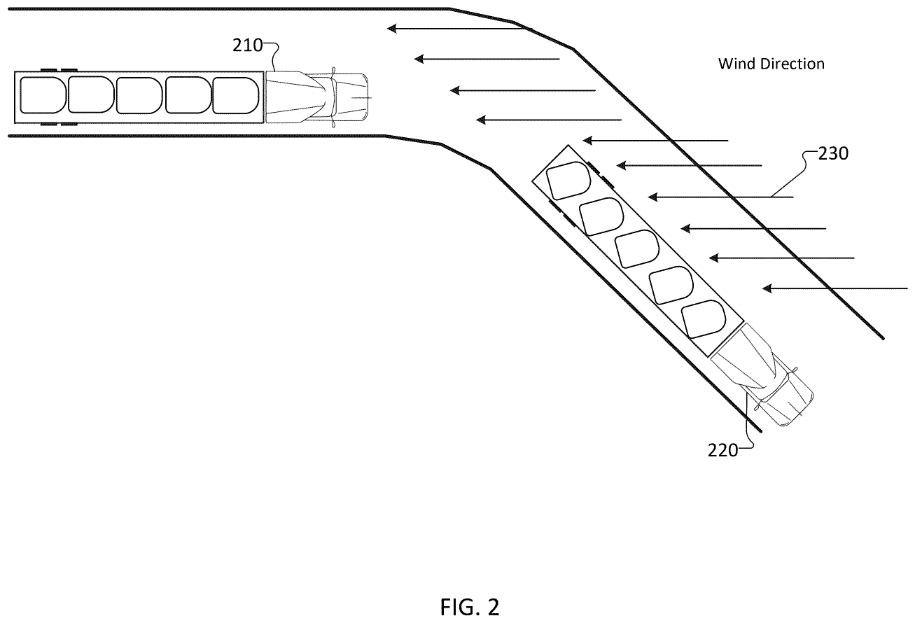

In addition, the safety and aerodynamic estimation 120 may use the orientation of the vehicle (e.g., its heading) and may predict future orientations of the vehicle based on road topological and positional information 103) (e.g., map data, GPS data, etc.). As such, the safety and aerodynamic estimation 120 may proactively determine adjustments to the orientation of the cargo/load based on the actual or predicted heading of the vehicle. For example, when the vehicle is approaching a curve that would cause another angle of attack of the wind (e.g., angle of incidence on the vehicle's surfaces), the safety and aerodynamic estimation 120 may take this into account. This is shown, for example, in FIG. 2 where a truck is depicted in two positions (a first position 210 and a second position 220) as it travels along a road. At first position 210, the truck is heading directly into the wind (shown by wind direction arrows 230). Knowing that the approaching curve will change the aerodynamics of the vehicle, the safety and aerodynamic estimation 120 may take this into account by adjusting the orientation of the load so as to make it more aerodynamic with respect to the new angle of incidence of the wind on the truck at second position 220.

Furthermore, the safety and aerodynamic estimation 120 may consider in its risk estimation current or predicted traffic conditions 105 in order to, for example, take into account the impact from nearby traffic participants and the impact to those participants. For example, if a vehicle is overtaking a truck in the presence of a strong side wind, the vehicle driver may anticipate a reduction in wind force when moving into/through the truck's wind shadow. In such a case, the safety and aerodynamic estimation 120 may recognize the passing vehicle and decide not to rotate its load to account for the presence of the side wind. This is because if the truck were to rotating its load, a very sudden and unexpected wind effect may hit the driver's vehicle, and the driver may not be prepared to react. Hence, the safety and aerodynamic estimation 120 may take into account such aspects in a rule-based manner, e.g., there may be a set of rules that determines when, where, under what conditions, and to what extent the adjustments to the orientation of the load (or any other adjustment) may be allowed.

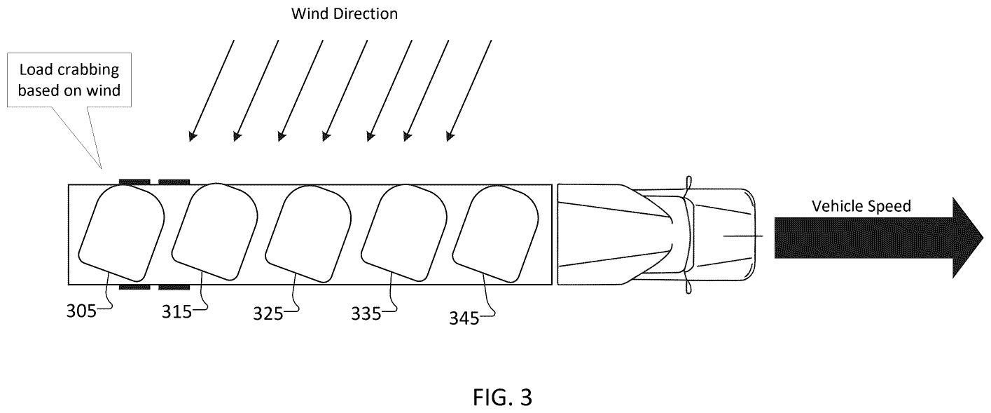

As should be understood, the vehicle may have active mechanical parts that may be controlled by the wind-based controller system 100 to, for example, change the orientation of the load/containers to improve the aerodynamics with respect to the wind. In this sense, this may be understood as “load crabbing” so as to orient the load to improve the aerodynamics of the vehicle with respect to the wind by, for example, reducing the cross-sectional area exposed to crosswinds, so as to improve overall vehicle safety and efficiency. An example of such load crabbing is shown in FIG. 3, where the trailer is fitted with multiple pallets/containers 305, 315, 325, 335, 345 that have been rotated to reduce the surface area exposed to the current wind condition. As should be understood, each of the multiple pallets/containers (e.g., 305, 315, 325, 335, 345) holding the load may be independently rotatable/moveable with respect to the truck bed. As noted above, the safety and aerodynamic estimation 120 may take into account actual or predicted conditions such as road geometry, weather, traffic situations, etc., in order to determine a suitable orientation of each load with respect to the wind for the current situation. While FIGS. 2 and 3 show five containers on the trailer, any shape or number of containers, pallets, holders, carriers, etc. may be used that may adaptively adjust their shape, orientation, location, etc., to improve wind-based aerodynamics.

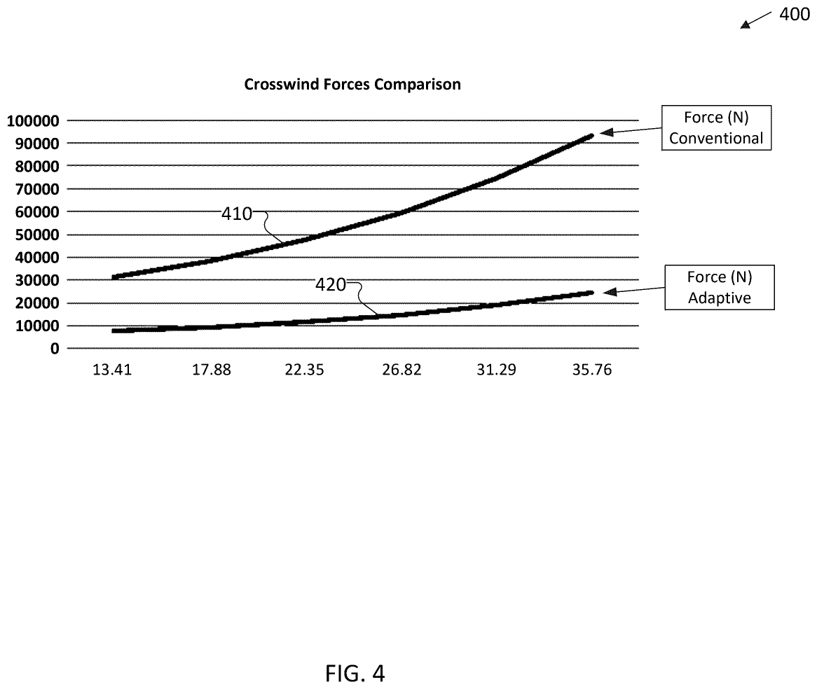

FIG. 4 shows a graph 400 for the amount of force acting on a vehicle due to crosswinds (e.g., drag), where force is plotted on the y-axis, in Newtons (N), for a given speed (m/s) of a cross-wind that is plotted on the x-axis. Line 410 shows a conventional truck that is not adaptable to wind conditions, while line 420 shows a truck with adaptable containers that may adjust the orientation of the load based on the angle of incidence of the crosswind on the load so as to reduce the side load force experienced by the vehicle. An example set of mathematics with respect to crosswind is discussed in more detail below, showing how the risk of falling over may be reduced by effectively reducing the surface area of the vehicle. By rotating the individual platforms/containers to rotate with respect to the wind, the overall aerodynamic drag may be reduced and the stability of the vehicle may be improved. By integrating real-time wind sensing and automated control, the adaptive wind-based controller system may enhance safety, minimizes lane deviation, and reduces fuel consumption of the truck. Thus, the adaptive wind-based controller system may provide a safer, more fuel-efficient wind solution for long-haul trucking, particularly in regions prone to strong lateral winds.

In the table below, the crosswind forces acting on a conventional vehicle (e.g., a “box” trailer without an adaptive wind-based controller system) are compared to the crosswind forces acting on a vehicle with an adaptive wind-based controller system to show the percentage of force reduction calculated from the data in graph 400 of FIG. 4. As seen from this data, the force reduction may be approximately 74%.

| Crosswind | Force (N) | Force (N) | Effective | | | Force |
|---|---|---|---|---|---|---|
| (m/s) | Conventional | Adaptive | Wind Speed | Cd − | Cd − | Reduction |
| [mph] | (line 410) | (line 420) | (m/s) | Conventional | Adaptive | (%) |
| 13.41 [30] | 31303.23 | 7568.96 | 26.06 | 1.618 | 0.407 | 75.82 |
| 17.88 [40] | 38187.04 | 9295.86 | 28.62 | 1.637 | 0.415 | 75.66 |
| 22.35 [50] | 47429.75 | 11666.81 | 31.61 | 1.667 | 0.427 | 75.4 |
| 26.82 [60] | 59386.07 | 14818.13 | 34.91 | 1.711 | 0.444 | 75.05 |
| 31.29 [70] | 74530.31 | 18932.06 | 38.45 | 1.77 | 0.468 | 74.6 |
| 35.76 [80] | 93462.93 | 24239.33 | 42.17 | 1.846 | 0.498 | 74.07 |

In the calculations above, the vehicle was assumed to be traveling at a baseline consistent speed of 50 miles per hour (mph) at variable crosswind speeds. The Python code used to produce this data set is listed below:

#constraints

$$\begin{matrix}rho = 1.225 \# kg / {m}^{3} , air density \\ v\_vehicle = 22.35 \# m / s , fixed vehicle speed ( 50 mph ) \\ A\_conventional = 3.05 * 15.24 \# {m}^{2} , frontal area for box trailer \\ A\_adaptive = 3.05 * 4.88 * 3 \# {m}^{2} , reduced frontal area for adaptive system\end{matrix}$$

#Crosswind speeds in mph and converted to m/s

$$\begin{matrix}crosswind\_speeds \_mph = [ 30 , 40 , 50 , 60 , 70 , 80 ] \\ crosswind\_speeds \_ms = [ speed * 0.44704 for speed in crosswind\_speeds \_mph ]\end{matrix}$$

#Function to calculate dynamic drag coefficient (Cd); increases Cd for conventional trailer due to turbulence at higher speeds; less increase in Cd for adaptive system due to streamlined shape

def dynamic_cd_conventional (v_effective):

$$\begin{matrix}return 1.6 + 0.0005 * ( v\_effective - 20 ) ** 2 \\ def dynamic\_cd \_adaptive ( v\_effective ) : \\ return 0.4 + 0.0002 * ( v\_effective - 20 ) ** 2\end{matrix}$$

#Function to calculate wind force based on velocity, area, and drag coefficient def calculate_wind_force (A, Cd, v_effective):

$$return 0.5 * rho * v\_effective ** 2 * A * Cd$$

#Compute forces and print to stdout for v_crosswind, v_crosswind_ms in zip (crosswind_speeds_mph, crosswind_speeds_ms): #Compute effective wind speed using Pythagorean theorem

$$v\_effective = math . sqrt ( v\_vehicle ** 2 + v\_crosswind \_ms ** 2 )$$

#Compute dynamic drag coefficients

$$\begin{matrix}Cd\_conventional = dynamic\_cd \_conventional ( v\_effective ) \\ Cd\_adaptive = dynamic\_cd \_adaptive ( v\_effective )\end{matrix}$$

#Compute forces for both configurations

$$\begin{matrix}force\_conventional = calculate\_wind \_force ( A\_conventional , Cd\_conventional , v\_effective \\ force\_adaptive = calculate\_wind \_force ( A\_adaptive , Cd\_adaptive , v\_effective )\end{matrix}$$

#Compute force reduction percentage

$$force\_reduction = ( 1 - ( force\_adaptive / force\_conventional ) ) * 100$$

In addition to rotating the pallets/containers in the trailer to improve the exposed surface area with respect to the wind direction, another adaptation may be that the adaptive wind-based controller system may adapt the cargo placement within a given fixed-size container based on the wind conditions. For example, referring to conventional “static” containers (regular box style trailers), the adaptive wind-based controller system may utilize a non-uniform load within a pallets/container, so that rotating it or repositioning it will adjust the balance of the trailer, which may be referred to as dynamic internal load rotation. As should be understood, the pallets/containers may be on adjustable tracks that allow the position of the load to be shifted within the trailer to adjust the balance of the trailer.

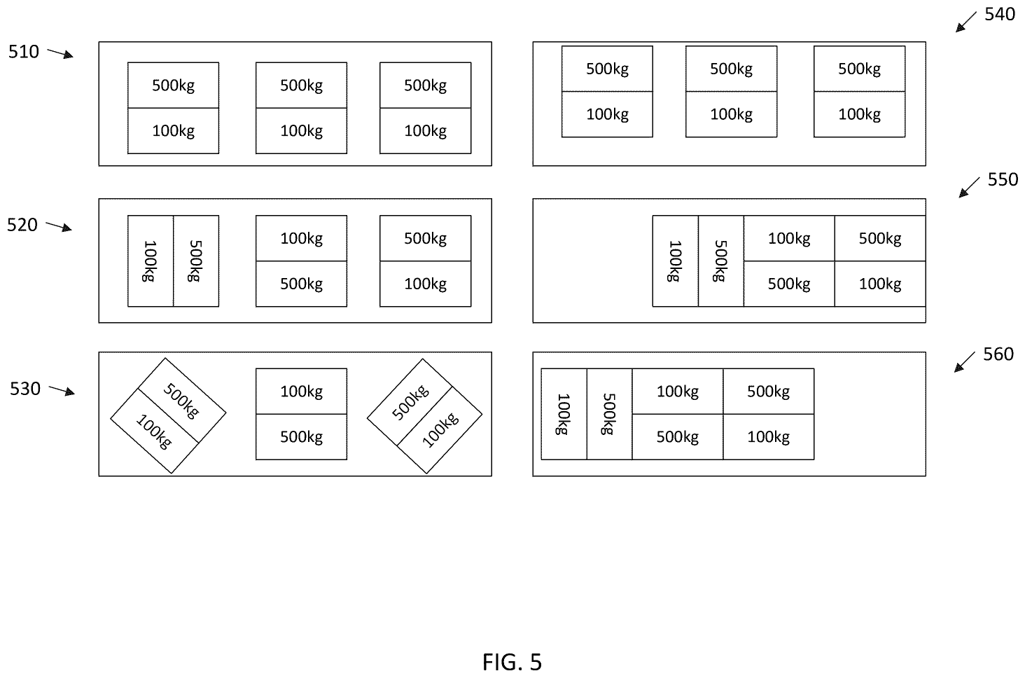

FIG. 5 shows a number of different views of how the arrangement of pallets within a trailer might be adapted so as to rebalance the trailer based on the wind so as to counteract the force of the wind. Each view shows three pallets, each with a non-uniform load (600 kg each, with 500 kg on one side and 100 kg on the other side) where the loads have been repositioned or reoriented to create an “unbalanced” trailer for offsetting the force caused by the wind. View 510 shows the three pallets centered in the trailer. View 520 shows the first pallet rotated by 90 degrees. View 530 shows the first pallet rotated 45 degrees and the third pallet rotated-45 degrees. View 540 shows all of the pallets shifted toward the top side of the trailer. View 550 shows all of the pallets shifted to the right side of the trailer. View 560 shows all of the pallets shifted to the left side of the trailer. Each of the different positions/orientations will rebalance the trailer differently, and the adaptive wind-based controller system may select the positional/orientational configuration of the load based on the wind conditions.

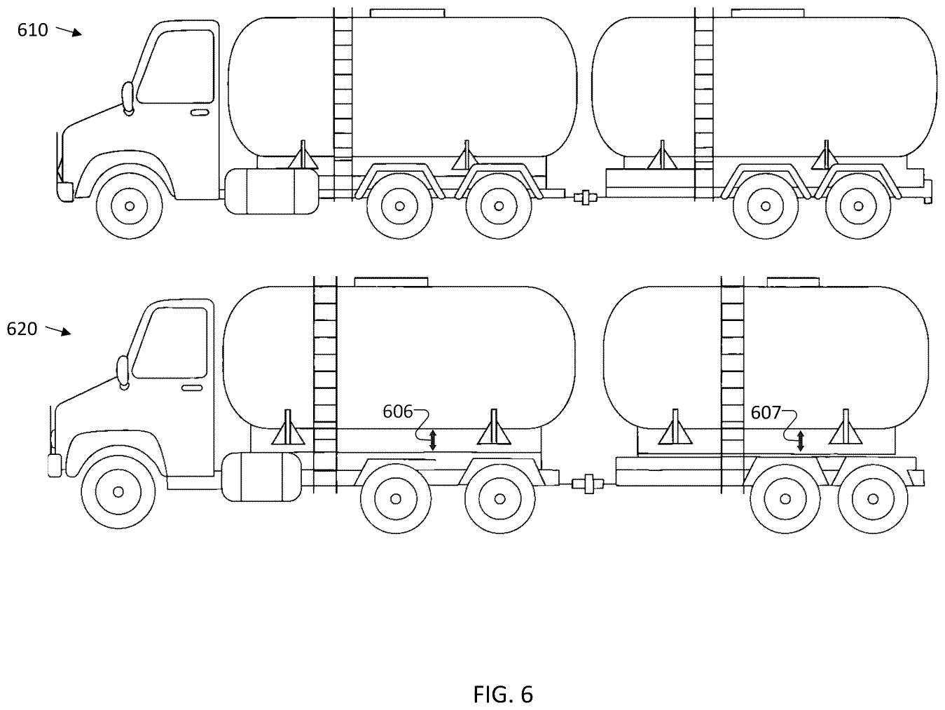

FIG. 6 shows views of another option for real-time wind-based adjustments, where the load may be dynamically lifted (using mechanical/hydraulic lifts) to create space under the load. View 610 shows tanks mounted on trailers by a hydraulic lift, where the lifts are lowered so that there is no airflow under the tanks. View 620 shows the tanks raised so that there is a gap 606, 607 under each tank to create so that air may flow underneath each tank, reducing drag.

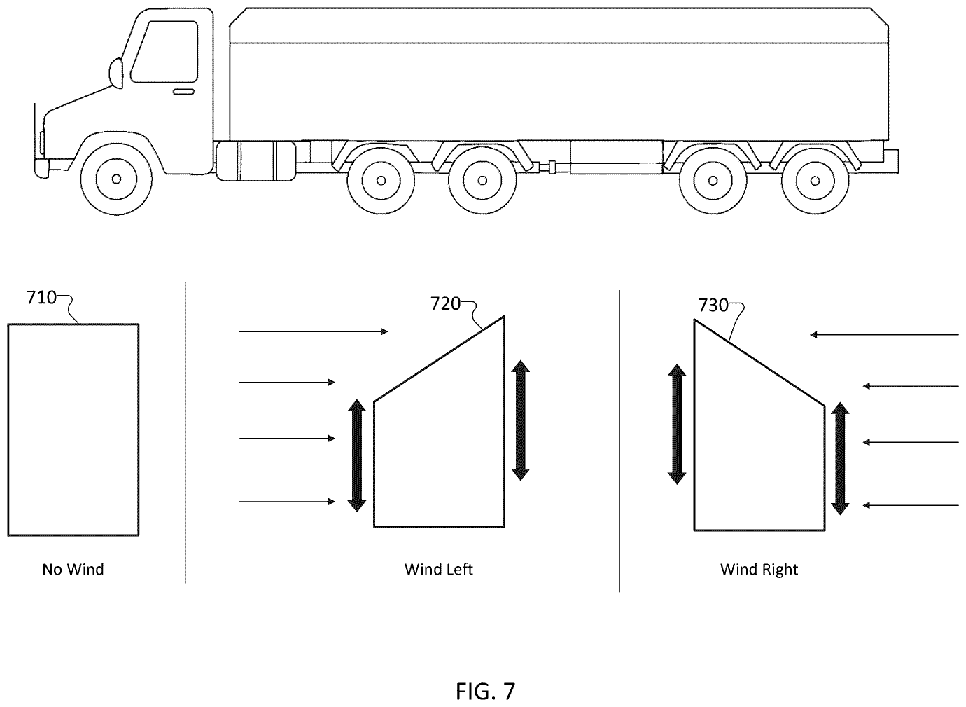

FIG. 7 shows three views of another option for real-time wind-based adjustments, where the aerodynamics (e.g., shape/height of trailer) may be dynamically adjusted based on the wind conditions. In view 710, this is the cross-sectional profile of a typical “box” semi trailer that is unadjusted (e.g., for times when there is no wind). View 720 shows a different profile where the adaptive wind-based controller system has adjusted the relative heights of the sides so that the right side is higher than the left side. This is because the adaptive wind-based controller system has determined a crosswind from the left, and increasing slope from left to right helps reduce the surface angle where the wind is incident and creates a downward force to help stabilize the trailer. View 730 shows a different profile where the adaptive wind-based controller system has adjusted the relative heights of the sides so that the left side is higher than the right side. This is because the adaptive wind-based controller system has determined a crosswind from the right, and increasing slope from right to left helps reduce the surface angle where the wind is incident and creates a downward force to help stabilize the trailer. As should be appreciated, other active aerodynamic elements, such as blades between the wheels, could be adjusted (e.g., pulled up/down) based on the wind conditions in order to reduce wind force and improve the stability of the trailer. Another option would be adjustable damping elements, where the adaptive wind-based controller system dynamically adjustments the stiffness of the dampers based on wind conditions (e.g., wind direction and force) to increase the stability of the trailer.

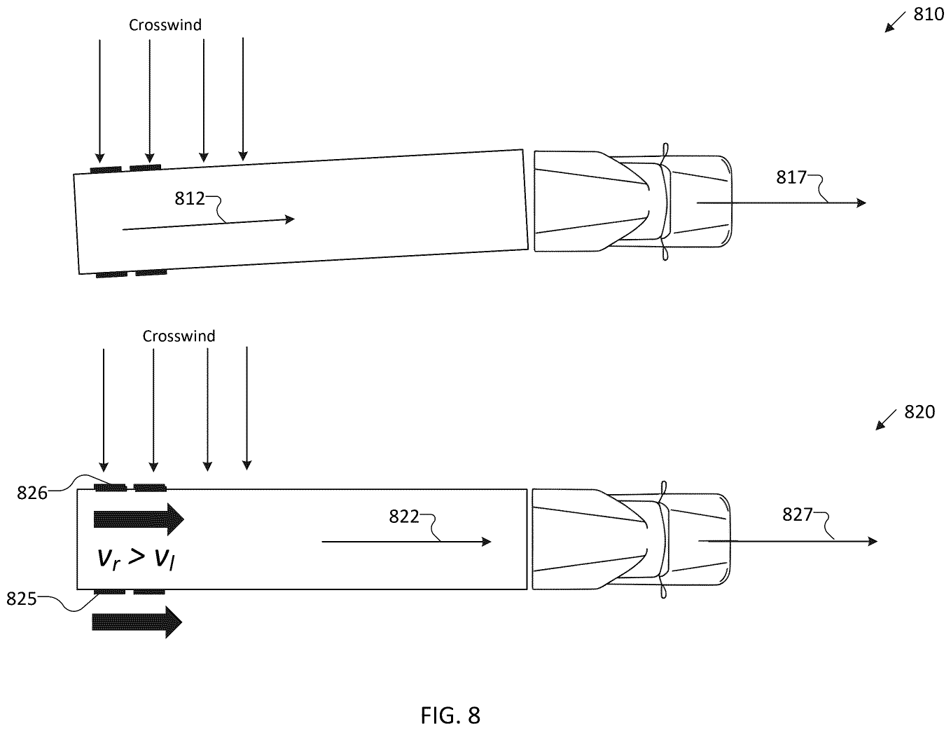

As another option, the adaptive wind-based controller system may use axel-based counter-steering that is based on the current wind conditions to mitigate its impact. For example, if the trailer has independently steerable axels, the adaptive wind-based controller system may adjust the steering to counteract the wind forces and keep the trailer driving in the desired direction without being pushed elsewhere. This adjustment is shown in the two views of FIG. 8, where in view 810, a crosswind is acting on the trailer (from the top of the page) and pushing the trailer to the side such that heading 812 of the trailer is not aligned with the ground heading 817 of the vehicle. In view 820, the adaptive wind-based controller system has increased the speed of wheels 825 (vr) as compared to the speed of wheels 826 (11) to counteract the wind-induced misalignment so that the heading 822 of the trailer is realigned with the ground heading 827 of the vehicle. This may be realized by, for example, a trailer that is equipped with electric drive on the axles of the trailer and batteries directly incorporated into the trailer (e.g., a so-called E-Trailer).

### Calculating Safety Risk

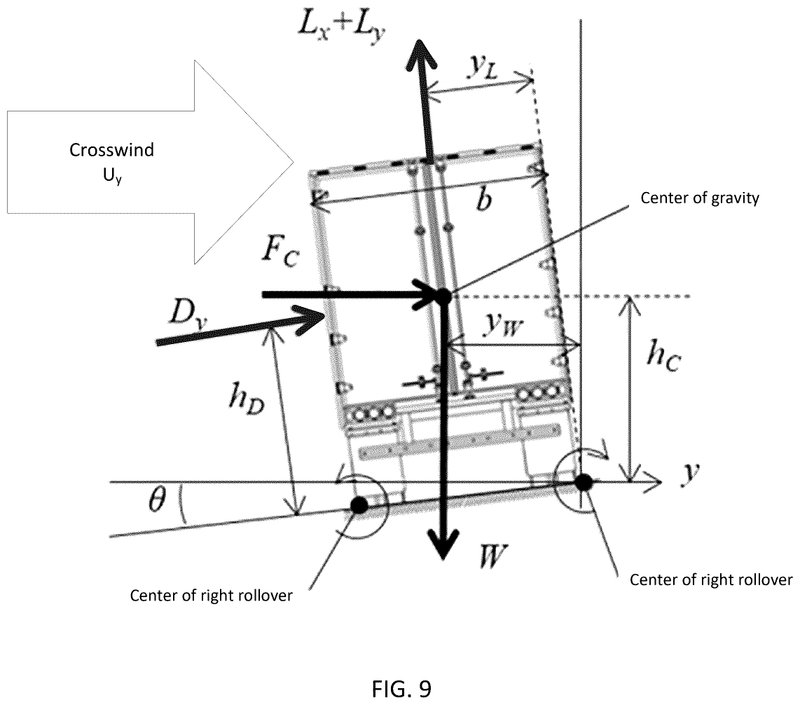

As noted earlier, the adaptive wind-based controller system may determine safety risk to the vehicle based on the wind conditions. Below are mathematic examples with respect to an example crosswind and how the adaptive wind-based controller system may determine based on the crosswind the safety risk to a common semitruck trailer with a “box” style load. FIG. 9 shows the various forces at play with respect to a semitruck that may rollover if the crosswind has sufficient force.

For purposes of an example calculation of how the adaptive wind-based controller system may improve vehicle efficiency, a physics model is also demonstrated. The trailer configuration consists of three containers, each 16 feet (4.88 meters) long, mounted on a flatbed frame. Each container features a curved leading edge designed to reduce drag when rotated into the wind. A wind alignment system of the adaptive wind-based controller system, equipped with sensors, detects the direction of crosswinds and adjusts the container orientation accordingly. This is managed by a computer-controlled mechanism of the adaptive wind-based controller system that dynamically rotates the containers to optimize the reduction of wind resistance.

### Physics of Crosswind Mitigation

### Conventional Box Trailer-Aerodynamic Forces

Assuming the following trailer dimensions and conditions:
Trailer Length: 50 feet (15.24 meters)
Trailer Height: 10 feet (3.05 meters)
Trailer Width: 8 feet (2.44 meters)
Wind Speed: 50 mph (22.35 m/s)
Air Density: 1.225 kg/m³
Drag Coefficient (Cd): 1.6

The aerodynamic force exerted by the crosswind may be given by the following relation (in Python-style notation):

$$F\_wind = 0.5 * rho * v ** 2 * A * Cd$$

In the above relation:

$$\begin{matrix}F\_wind = Wind force ( N ) \\ rho = Air density ( kg / {m}^{3} ) \\ v = Wind velocity ( m / s ) \\ A = Exposed surface area ( {m}^{2} ) \\ Cd = Drag coefficient\end{matrix}$$

For a conventional box trailer, using the following Python code example, the aerodynamic forces may be determined by:

$$\begin{matrix}A = 3.05 * 15.24 \# {m}^{2} ∼ area in meters squared \\ F\_wind = 0.5 * 1.225 * ( 22. 35 ) ** 2 * A * 1.6 \\ rho = 1.225 \# kg / {m}^{3} , air density \\ v = 22.35 \# m / s , wind speed \\ A = 3.05 * 15.24 \# {m}^{2} , exposed surface area \\ Cd = 1.6 \# Drag coefficient for a box trailer\end{matrix}$$

#Calculate wind force (Python code)

$$\begin{matrix}F\_wind = 0.5 * rho * v ** 2 * A * Cd \\ F\_wind \# just output result \\ Result = 22754.428748100006\end{matrix}$$

Thus, the resulting wind force acting on the conventional box trailer is approximately 22,754 N. This indicates a significant lateral force exerted by the crosswind, which increases the risk of lane deviation or rollover, especially at high speeds.

### Adaptive Load Orientation System—Reduced Crosswind Impact

Next, a model is used to show how an adaptive wind-based controller system may reduce crosswind impact by rotating three adjustable containers to aligning their leading edges into the crosswind to improving the aerodynamic profile with respect to the crosswind. The purpose of this model is to provide a comparison of the adaptive wind-based controller system to a conventional load system. As noted in the earlier discussion of FIG. 4 and the table above, those calculations compared the wind forces acting on a conventional semi and one with an adaptive wind-based controller system at various crosswind speeds, taking into account the dynamic nature of drag coefficients as the effective wind speed changes.

### Conventional Load System

Frontal Area: The conventional load system is modeled as a box trailer with a frontal area of 3.05*15.24=46.482 square meters. This represents the exposed surface area that interacts with the wind.

Drag Coefficient: The drag coefficient for the conventional system starts at 1.6. However, it increases dynamically with the effective wind speed due to turbulence. The formula used is: C_{d_conventional}=1.6+0.0005*(v_{effective}−20)². This accounts for the increased aerodynamic drag as the speed increases.

Force Calculation: The wind force on the conventional system is calculated using the formula: F_{wind}=0.5*ρ *v_{effective}²*A*C_{d} where ρ is the air density of 1.225 kg/m³, v_{effective} is the effective wind speed, A is the frontal area, and C_{d} is the drag coefficient.

### Adaptive Load System

Frontal Area: The adaptive load system is designed to reduce the effective frontal area, calculated as 3.05*4.88*3=44.652 square meters. This configuration aims to minimize the surface area exposed to the wind.

Drag Coefficient: The drag coefficient for the adaptive system starts at 0.4, reflecting its streamlined shape. It also increases with effective wind speed, but at a slower rate compared to the conventional system. The formula used is: C_{d_adaptive}=0.4+0.0002*(v_{effective}-20)². This reflects the improved aerodynamic efficiency of the adaptive system.

Force Calculation: Similar to the conventional system, the wind force on the adaptive system is calculated using the same formula, but with its respective area and drag coefficient.

### Methodology

Effective Wind Speed: The effective wind speed is calculated using the Pythagorean theorem, combining the fixed vehicle speed (22.35 m/s) and the crosswind speed (converted from mph to m/s). This gives a more realistic measure of the wind's impact on the vehicle.

Comparison: For each crosswind speed, the script calculates the wind forces for both systems and determines the percentage reduction in force achieved by the adaptive system compared to the conventional system. This is expressed as:

$$Force Reduction ( \% ) = ( 1 - \frac{{Force}_{adaptive}}{{Force}_{conventional}} ) * 100$$

As should be understood, this is merely exemplary to show how the adaptive wind-based controller system may reduce aerodynamic forces and improve stability under varying crosswind conditions. In this example, the effective drag coefficient is estimated to be reduced from 1.6 to 0.4, indicating a fourfold improvement, estimated based on how aerodynamic shapes (e.g. nose cone) may improve air flow as compared to flat surfaces.

The table below summarizes the comparison of the results and benefits.

| | Conventional | Adaptive Load |
|---|---|---|
| Parameter | Box Trailer | System |
| Drag Coefficient | Varies | Varies |
| (Cd) | (1.618 to 1.846) | (0.407 to 0.498) |
| Exposed Surface | 46.47 | 44.64 |
| Area (m²) | | |
| Crosswind | High | Significantly Lower |
| Force (N) | (31,303.23 to 93,462.93) | (7,568.96 to 24,239.33) |
| Force Reduction | — | 74.07% to 75.82% |
| (%) | | |
| Rollover Risk | High | Greatly Reduced |

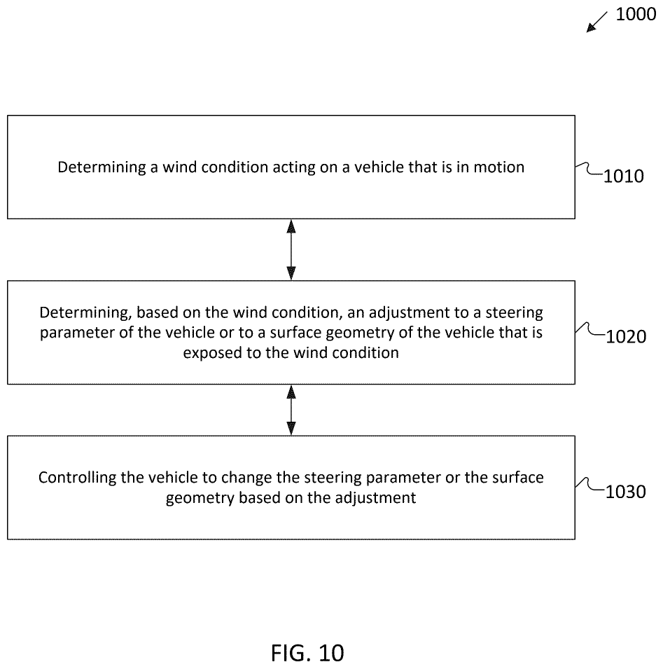

FIG. 10 depicts a schematic flow diagram of a method 1000 for adapting a vehicle's steering, load position, or aerodynamics based on current wind conditions. Method 1000 may implement any of the features discussed above with respect to the adaptive wind-based controller system and/or FIGS. 1-9. Method 1000 includes, in 1010, determining a wind condition acting on a vehicle that is in motion. Method 1000 also include, in 1020, determining, based on the wind condition, an adjustment to a steering parameter of the vehicle or to a surface geometry of the vehicle that is exposed to the wind condition. Method 1000 also includes, in 1030, controlling the vehicle to change the steering parameter or the surface geometry based on the adjustment.

In the following, various examples are provided that may include one or more aspects described with reference to the adaptive wind-based controller system discussed above and/or any of FIGS. 1-10. The examples provided in relation to the devices may apply also to the described method(s), and vice versa.

Example 1 is an apparatus including a memory including instructions stored thereon. The apparatus also includes a processor that, based on execution of the instructions, is configured to determine a wind condition acting on a vehicle that is in motion. The processor is also configured to determine, based on the wind condition, an adjustment to a steering parameter of the vehicle or to a surface geometry of the vehicle that is exposed to the wind condition. The processor is also configured to control the vehicle to change the steering parameter or the surface geometry based on the adjustment.

Example 2 is the apparatus of example 1, wherein the wind condition includes an angle of incidence of a wind vector acting on the vehicle.

Example 3 is the apparatus of any one of examples 1 to 2, wherein the wind condition includes a wind speed of a wind vector acting on the vehicle.

Example 4 is the apparatus of any one of examples 1 to 3, wherein the adjustment to the surface geometry includes a rotation to a cargo platform of the vehicle.

Example 5 is the apparatus of example 4, wherein the wind condition includes an angle of incidence of a wind vector acting on cargo mounted on the cargo platform, wherein the rotation changes the angle of incidence of the wind vector acting on the cargo.

Example 6 is the apparatus of any one of examples 4 to 5, wherein the cargo platform includes a plurality of independently rotatable cargo platforms, wherein the adjustment includes a plurality of rotations, each corresponding to an independent rotation of one of the plurality of independently rotatable cargo platforms.

Example 7 is the apparatus of example 6, wherein the vehicle includes a truck with a tractor and a trailer, wherein the cargo platform is mounted on the trailer of the truck.

Example 8 is the apparatus of any one of examples 1 to 7, wherein the adjustment to the steering parameter includes a crabbing of a wheel of the vehicle.

Example 9 is the apparatus of example 8, wherein the crabbing defines a lateral adjustment of an alignment of the wheel to the vehicle, wherein the alignment enables the vehicle to move at an angle relative to a longitudinal axis of the vehicle with respect to motion of the vehicle.

Example 10 is the apparatus of example 8, wherein the crabbing includes a crabbing angle between a heading angle in which the vehicle is pointed and a track angle in which the vehicle is traveling with respect to ground.

Example 11 is the apparatus of any one of examples 1 to 10, wherein the adjustment to the steering parameter includes a differential of rotational torque of a first wheel as compared to a second wheel of the vehicle.

Example 12 is the apparatus of example 11, wherein the differential of rotational torque includes the first wheel subject to a first driving force for rotating the first wheel and the second wheel subject to a second driving force for rotating the second wheel, wherein the first driving force is different from the second driving force.

Example 13 is the apparatus of example 12, wherein the processor is configured to apply the first driving force to the first wheel and the second driving force to the second wheel.

Example 14 is the apparatus of example 12, wherein the vehicle comprises a trailer coupled with a tractor, wherein the first wheel is located on one side of the trailer and the second wheel is on the second side of the trailer opposite to the first side, wherein the first driving force of the first wheel and the second driving force of the second wheel are independently drivable.

Example 15 is the apparatus of any one of examples 1 to 14, wherein the adjustment is based on a reduction to a drag coefficient on the vehicle from the wind condition.

Example 16 is the apparatus of any one of examples 1 to 15, wherein the processor configured to determine the wind condition includes processor configured to receive data from a sensor, wherein the data is indicative of a wind speed and/or an angle of incidence of the wind condition at the vehicle.

Example 17 is the apparatus of any one of examples 1 to 16, wherein processor configured to determine the wind condition includes the processor configured to receive load sensor data that is indicative of a vertical force distribution among wheels of the vehicle and determine the wind condition from the vertical force distribution.

Example 18 is the apparatus of any one of examples 1 to 17, wherein determining the wind condition includes receiving weather data for a physical location in which the vehicle is traveling.

Example 19 is the apparatus of any one of examples 1 to 18, wherein the processor is configured to determine a safety hazard for the vehicle based on the wind condition and a current or planned motion of the vehicle, wherein the adjustment is configured to decrease the safety hazard.

Example 20 is the apparatus of example 19, wherein the safety hazard includes a risk of the vehicle tipping over.

Example 21 is the apparatus of any one of examples 1 to 20, wherein the adjustment to the surface geometry includes a reshaping of the surface geometry of the vehicle to change its aerodynamic profile.

Example 22 is the apparatus of example 21, wherein the reshaping of the surface geometry includes a deformation, an extension, a retraction, or a contour adjustment of at least one surface of the vehicle exposed to the wind condition.

Example 23 is the apparatus of any one of examples 1 to 22, wherein the adjustment is configured to reduce aerodynamic drag or improve vehicle safety.

Example 24 is the apparatus of any one of examples 1 to 23, wherein the processor is further configured to determine a predicted change in the wind condition based on a road topology and determine the surface geometry or steering parameter based on the predicted change.

Example 25 is the apparatus of any one of examples 1 to 24, wherein the processor is configured to determine the adjustment based on a safety rule set for the vehicle, wherein the safety rule set includes a safety constraint on a motion of the vehicle, wherein the safety rule set is based on environmental conditions, traffic conditions, or wind shadowing effects.

Example 26 is the apparatus of any one of examples 1 to 25, wherein the processor is configured to determine the adjustment based on a vehicle stability and an aerodynamic drag associated with the wind condition.

Example 27 is the apparatus of any one of examples 1 to 26, wherein the processor is configured to determine the adjustment based on a mathematical model that relates the adjustment with wind force, surface area, vehicle speed, and/or fuel consumption associated with the wind condition.

Example 28 is the apparatus of any one of examples 1 to 27, wherein the processor is configured to determine, based on the wind condition, a center of gravity adjustment to counteract a torque acting on the vehicle due to the wind condition.

Example 29 is the apparatus of example 28, wherein the center of gravity adjustment includes a redistribution or relocation of a load in the vehicle to provide a restoring moment with respect to the torque.

Example 30 is a non-transitory computer-readable medium comprising instructions that, when executed by one or more processors, cause the one or more processors to determine a wind condition acting on a vehicle that is in motion. The instructions also cause the one or more processors to determine, based on the wind condition, an adjustment to a steering parameter of the vehicle or to a surface geometry of the vehicle that is exposed to the wind condition. The instructions also cause the one or more processors to control the vehicle to change the steering parameter or the surface geometry based on the adjustment.

Example 31 is the non-transitory computer-readable medium of example 30, wherein the wind condition includes an angle of incidence of a wind vector acting on the vehicle.

Example 32 is the non-transitory computer-readable medium of any one of examples 30 to 31, wherein the wind condition includes a wind speed of a wind vector acting on the vehicle.

Example 33 is the non-transitory computer-readable medium of any one of examples 30 to 32, wherein the adjustment to the surface geometry includes a rotation to a cargo platform of the vehicle.

Example 34 is the non-transitory computer-readable medium of example 33, wherein the wind condition includes an angle of incidence of a wind vector acting on cargo mounted on the cargo platform, wherein the rotation changes the angle of incidence of the wind vector acting on the cargo.

Example 35 is the non-transitory computer-readable medium of any one of examples 33 to 34, wherein the cargo platform includes a plurality of independently rotatable cargo platforms, wherein the adjustment includes a plurality of rotations, each corresponding to an independent rotation of one of the plurality of independently rotatable cargo platforms.

Example 36 is the non-transitory computer-readable medium of example 35, wherein the vehicle includes a truck with a tractor and a trailer, wherein the cargo platform is mounted on the trailer of the truck.

Example 37 is the non-transitory computer-readable medium of any one of examples 30 to 36, wherein the adjustment to the steering parameter includes a crabbing of a wheel of the vehicle.

Example 38 is the non-transitory computer-readable medium of example 37, wherein the crabbing defines a lateral adjustment of an alignment of the wheel to the vehicle, wherein the alignment enables the vehicle to move at an angle relative to a longitudinal axis of the vehicle with respect to motion of the vehicle.

Example 39 is the non-transitory computer-readable medium of example 37, wherein the crabbing includes a crabbing angle between a heading angle in which the vehicle is pointed and a track angle in which the vehicle is traveling with respect to ground.

Example 40 is the non-transitory computer-readable medium of any one of examples 30 to 39, wherein the adjustment to the steering parameter includes a differential of rotational torque of a first wheel as compared to a second wheel of the vehicle.

Example 41 is the non-transitory computer-readable medium of example 40, wherein the differential of rotational torque includes the first wheel subject to a first driving force for rotating the first wheel and the second wheel subject to a second driving force for rotating the second wheel, wherein the first driving force is different from the second driving force.

Example 42 is the non-transitory computer-readable medium of example 41, wherein the instructions also cause the one or more processors to apply the first driving force to the first wheel and the second driving force to the second wheel.

Example 43 is the non-transitory computer-readable medium of example 41, wherein the vehicle comprises a trailer coupled with a tractor, wherein the first wheel is located on one side of the trailer and the second wheel is on the second side of the trailer opposite to the first side, wherein the first driving force of the first wheel and the second driving force of the second wheel are independently drivable.

Example 44 is the non-transitory computer-readable medium of any one of examples 30 to 43, wherein the adjustment is based on a reduction to a drag coefficient on the vehicle from the wind condition.

Example 45 is the non-transitory computer-readable medium of any one of examples 30 to 44, wherein the instructions also cause the one or more processors to determine the wind condition includes processor configured to receive data from a sensor, wherein the data is indicative of a wind speed and/or an angle of incidence of the wind condition at the vehicle.

Example 46 is the non-transitory computer-readable medium of any one of examples 30 to 45, wherein the instructions that cause the one or more processors to determine the wind condition includes that the instructions also cause the one or more processors to receive load sensor data that is indicative of a vertical force distribution among wheels of the vehicle and determine the wind condition from the vertical force distribution.

Example 47 is the non-transitory computer-readable medium of any one of examples 30 to 46, wherein the instructions that cause the one or more processors to determine the wind condition includes that the instructions also cause the one or more processors to receive weather data for a physical location in which the vehicle is traveling.

Example 48 is the non-transitory computer-readable medium of any one of examples 30 to 47, wherein the instructions also cause the one or more processors to determine a safety hazard for the vehicle based on the wind condition and a current or planned motion of the vehicle, wherein the adjustment is configured to decrease the safety hazard.

Example 49 is the non-transitory computer-readable medium of example 48, wherein the safety hazard includes a risk of the vehicle tipping over.

Example 50 is the non-transitory computer-readable medium of any one of examples 30 to 49, wherein the adjustment to the surface geometry includes a reshaping of the surface geometry of the vehicle to change its aerodynamic profile.

Example 51 is the non-transitory computer-readable medium of example 50, wherein the reshaping of the surface geometry includes a deformation, an extension, a retraction, or a contour adjustment of at least one surface of the vehicle exposed to the wind condition.

Example 52 is the non-transitory computer-readable medium of any one of examples 30 to 51, wherein the adjustment is configured to reduce aerodynamic drag or improve vehicle safety.

Example 53 is the non-transitory computer-readable medium of any one of examples 30 to 52, wherein the instructions further cause the one or more processors to determine a predicted change in the wind condition based on a road topology and determine the surface geometry or steering parameter based on the predicted change.

Example 54 is the non-transitory computer-readable medium of any one of examples 30 to 53, wherein the instructions also cause the one or more processors to determine the adjustment based on a safety rule set for the vehicle, wherein the safety rule set includes a safety constraint on a motion of the vehicle, wherein the safety rule set is based on environmental conditions, traffic conditions, or wind shadowing effects.

Example 55 is the non-transitory computer-readable medium of any one of examples 30 to 54, wherein the instructions also cause the one or more processors to determine the adjustment based on a vehicle stability and an aerodynamic drag associated with the wind condition.

Example 56 is the non-transitory computer-readable medium of any one of examples 30 to 55, wherein the instructions further cause the one or more processors to determine the adjustment based on a mathematical model that relates the adjustment with wind force, surface area, vehicle speed, and/or fuel consumption associated with the wind condition.

Example 57 is the non-transitory computer-readable medium of any one of examples 30 to 56, wherein the instructions further cause the one or more processors to determine, based on the wind condition, a center of gravity adjustment to counteract a torque acting on the vehicle due to the wind condition.

Example 58 is the non-transitory computer-readable medium of example 57, wherein the center of gravity adjustment includes a redistribution or relocation of a load in the vehicle to provide a restoring moment with respect to the torque.

Example 59 is a method including determining a wind condition acting on a vehicle that is in motion. The method also includes determining, based on the wind condition, an adjustment to a steering parameter of the vehicle or to a surface geometry of the vehicle that is exposed to the wind condition. The method also includes controlling the vehicle to change the steering parameter or the surface geometry based on the adjustment.

Example 60 is the method of example 59, wherein the wind condition includes an angle of incidence of a wind vector acting on the vehicle.

Example 61 is the method of any one of examples 59 to 60, wherein the wind condition includes a wind speed of a wind vector acting on the vehicle.

Example 62 is the method of any one of examples 59 to 61, wherein the adjustment to the surface geometry includes a rotation to a cargo platform of the vehicle.

Example 63 is the method of example 62, wherein the wind condition includes an angle of incidence of a wind vector acting on cargo mounted on the cargo platform, wherein the rotation changes the angle of incidence of the wind vector acting on the cargo.

Example 64 is the method of any one of examples 62 to 63, wherein the cargo platform includes a plurality of independently rotatable cargo platforms, wherein the adjustment includes a plurality of rotations, each corresponding to an independent rotation of one of the plurality of independently rotatable cargo platforms.

Example 65 is the method of example 64, wherein the vehicle includes a truck with a tractor and a trailer, wherein the cargo platform is mounted on the trailer of the truck.

Example 66 is the method of any one of examples 59 to 65, wherein the adjustment to the steering parameter includes a crabbing of a wheel of the vehicle.

Example 67 is the method of example 66, wherein the crabbing defines a lateral adjustment of an alignment of the wheel to the vehicle, wherein the alignment enables the vehicle to move at an angle relative to a longitudinal axis of the vehicle with respect to motion of the vehicle.

Example 68 is the method of example 66, wherein the crabbing includes a crabbing angle between a heading angle in which the vehicle is pointed and a track angle in which the vehicle is traveling with respect to ground.

Example 69 is the method of any one of examples 59 to 68, wherein the adjustment to the steering parameter includes a differential of rotational torque of a first wheel as compared to a second wheel of the vehicle.

Example 70 is the method of example 69, wherein the differential of rotational torque includes the first wheel subject to a first driving force for rotating the first wheel and the second wheel subject to a second driving force for rotating the second wheel, wherein the first driving force is different from the second driving force.

Example 71 is the method of example 70, the method further including applying the first driving force to the first wheel and the second driving force to the second wheel.

Example 72 is the method of example 70, wherein the vehicle comprises a trailer coupled with a tractor, wherein the first wheel is located on one side of the trailer and the second wheel is on the second side of the trailer opposite to the first side, wherein the first driving force of the first wheel and the second driving force of the second wheel are independently drivable.

Example 73 is the method of any one of examples 59 to 72, wherein the adjustment is based on a reduction to a drag coefficient on the vehicle from the wind condition.

Example 74 is the method of any one of examples 59 to 73, wherein the determining the wind condition includes receiving data from a sensor, wherein the data is indicative of a wind speed and/or an angle of incidence of the wind condition at the vehicle.

Example 75 is the method of any one of examples 59 to 74, wherein the determining the wind condition includes receiving load sensor data that is indicative of a vertical force distribution among wheels of the vehicle and determining the wind condition from the vertical force distribution.

Example 76 is the method of any one of examples 59 to 75, wherein the determining the wind condition includes receiving weather data for a physical location in which the vehicle is traveling.

Example 77 is the method of any one of examples 59 to 76, the method further including determining a safety hazard for the vehicle based on the wind condition and a current or planned motion of the vehicle, wherein the adjustment is configured to decrease the safety hazard.

Example 78 is the method of example 77, wherein the safety hazard includes a risk of the vehicle tipping over.

Example 79 is the method of any one of examples 59 to 78, wherein the adjustment to the surface geometry includes a reshaping of the surface geometry of the vehicle to change its aerodynamic profile.

Example 80 is the method of example 79, wherein the reshaping of the surface geometry includes a deformation, an extension, a retraction, or a contour adjustment of at least one surface of the vehicle exposed to the wind condition.

Example 81 is the method of any one of examples 59 to 80, wherein the adjustment is configured to reduce aerodynamic drag or improve vehicle safety.

Example 82 is the method of any one of examples 59 to 81, the method further including determining a predicted change in the wind condition based on a road topology and determine the surface geometry or steering parameter based on the predicted change.

Example 83 is the method of any one of examples 59 to 82, the method further including determining the adjustment based on a safety rule set for the vehicle, wherein the safety rule set includes a safety constraint on a motion of the vehicle, wherein the safety rule set is based on environmental conditions, traffic conditions, or wind shadowing effects.

Example 84 is the method of any one of examples 59 to 83, the method further including determining the adjustment based on a vehicle stability and an aerodynamic drag associated with the wind condition.

Example 85 is the method of any one of examples 59 to 84, the method further including determining the adjustment based on a mathematical model that relates the adjustment with wind force, surface area, vehicle speed, and/or fuel consumption associated with the wind condition.

Example 86 is the method of any one of examples 59 to 85, the method further including determining, based on the wind condition, a center of gravity adjustment to counteract a torque acting on the vehicle due to the wind condition.

Example 87 is the method of example 86, wherein the center of gravity adjustment includes a redistribution or relocation of a load in the vehicle to provide a restoring moment with respect to the torque.

Example 88 is a device including a means for determining a wind condition acting on a vehicle that is in motion. The device also includes a means for determining, based on the wind condition, an adjustment to a steering parameter of the vehicle or to a surface geometry of the vehicle that is exposed to the wind condition. The device also includes a means for controlling the vehicle to change the steering parameter or the surface geometry based on the adjustment.

Example 89 is the device of example 88, wherein the wind condition includes an angle of incidence of a wind vector acting on the vehicle.

Example 90 is the device of any one of examples 88 to 89, wherein the wind condition includes a wind speed of a wind vector acting on the vehicle.

Example 91 is the device of any one of examples 88 to 90, wherein the adjustment to the surface geometry includes a rotation to a cargo platform of the vehicle.

Example 92 is the device of example 91, wherein the wind condition includes an angle of incidence of a wind vector acting on cargo mounted on the cargo platform, wherein the rotation changes the angle of incidence of the wind vector acting on the cargo.

Example 93 is the device of any one of examples 91 to 92, wherein the cargo platform includes a plurality of independently rotatable cargo platforms, wherein the adjustment includes a plurality of rotations, each corresponding to an independent rotation of one of the plurality of independently rotatable cargo platforms.

Example 94 is the device of example 93, wherein the vehicle includes a truck with a tractor and a trailer, wherein the cargo platform is mounted on the trailer of the truck.

Example 95 is the device of any one of examples 88 to 94, wherein the adjustment to the steering parameter includes a crabbing of a wheel of the vehicle.

Example 96 is the device of example 95, wherein the crabbing defines a lateral adjustment of an alignment of the wheel to the vehicle, wherein the alignment enables the vehicle to move at an angle relative to a longitudinal axis of the vehicle with respect to motion of the vehicle.

Example 97 is the device of example 95, wherein the crabbing includes a crabbing angle between a heading angle in which the vehicle is pointed and a track angle in which the vehicle is traveling with respect to ground.

Example 98 is the device of any one of examples 88 to 97, wherein the adjustment to the steering parameter includes a differential of rotational torque of a first wheel as compared to a second wheel of the vehicle.

Example 99 is the device of example 98, wherein the differential of rotational torque includes the first wheel subject to a first driving force for rotating the first wheel and the second wheel subject to a second driving force for rotating the second wheel, wherein the first driving force is different from the second driving force.

Example 100 is the device of example 99, the device further including a means for applying the first driving force to the first wheel and the second driving force to the second wheel.

Example 101 is the device of example 99, wherein the vehicle comprises a trailer coupled with a tractor, wherein the first wheel is located on one side of the trailer and the second wheel is on the second side of the trailer opposite to the first side, wherein the first driving force of the first wheel and the second driving force of the second wheel are independently drivable.

Example 102 is the device of any one of examples 88 to 101, wherein the adjustment is based on a reduction to a drag coefficient on the vehicle from the wind condition.

Example 103 is the device of any one of examples 88 to 102, wherein the means for determining the wind condition includes a means for receiving data from a sensor, wherein the data is indicative of a wind speed and/or an angle of incidence of the wind condition at the vehicle.

Example 104 is the device of any one of examples 88 to 103, wherein the means for determining the wind condition includes a means for receiving load sensor data that is indicative of a vertical force distribution among wheels of the vehicle and a means for determining the wind condition from the vertical force distribution.

Example 105 is the device of any one of examples 88 to 104, wherein the means for determining the wind condition includes a means for receiving weather data for a physical location in which the vehicle is traveling.

Example 106 is the device of any one of examples 88 to 105, the device further including a means for determining a safety hazard for the vehicle based on the wind condition and a current or planned motion of the vehicle, wherein the adjustment is configured to decrease the safety hazard.

Example 107 is the device of example 106, wherein the safety hazard includes a risk of the vehicle tipping over.

Example 108 is the device of any one of examples 88 to 107, wherein the adjustment to the surface geometry includes a reshaping of the surface geometry of the vehicle to change its aerodynamic profile.

Example 109 is the device of example 108, wherein the reshaping of the surface geometry includes a deformation, an extension, a retraction, or a contour adjustment of at least one surface of the vehicle exposed to the wind condition.

Example 110 is the device of any one of examples 88 to 109, wherein the adjustment is configured to reduce aerodynamic drag or improve vehicle safety.

Example 111 is the device of any one of examples 88 to 110, the device further including a means for determining a predicted change in the wind condition based on a road topology and a means for determining the surface geometry or steering parameter based on the predicted change.

Example 112 is the device of any one of examples 88 to 111, the device further including a means for determining the adjustment based on a safety rule set for the vehicle, wherein the safety rule set includes a safety constraint on a motion of the vehicle, wherein the safety rule set is based on environmental conditions, traffic conditions, or wind shadowing effects.

Example 113 is the device of any one of examples 88 to 112, the device further including a means for determining the adjustment based on a vehicle stability and an aerodynamic drag associated with the wind condition.

Example 114 is the device of any one of examples 88 to 113, the device further including a means for determining the adjustment based on a mathematical model that relates the adjustment with wind force, surface area, vehicle speed, and/or fuel consumption associated with the wind condition.

Example 115 is the device of any one of examples 88 to 114, the device further including a means for determining, based on the wind condition, a center of gravity adjustment to counteract a torque acting on the vehicle due to the wind condition.

Example 116 is the device of example 115, wherein the center of gravity adjustment includes a redistribution or relocation of a load in the vehicle to provide a restoring moment with respect to the torque.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. An apparatus comprising:
a memory comprising instructions stored thereon; and
a processor that, based on execution of the instructions, is configured to:
determine a wind condition acting on a vehicle that is in motion;
determine, based on the wind condition, an adjustment to a steering parameter of the vehicle or to a surface geometry of the vehicle that is exposed to the wind condition; and
control the vehicle to change the steering parameter or the surface geometry based on the adjustment.

2. The apparatus of claim 1, wherein the wind condition comprises an angle of incidence of a wind vector acting on the vehicle or a wind speed of a wind vector acting on the vehicle.

3. The apparatus of claim 1, wherein the adjustment to the surface geometry comprises a rotation to a cargo platform of the vehicle.

4. The apparatus of claim 3, wherein the wind condition comprises an angle of incidence of a wind vector acting on cargo mounted on the cargo platform, wherein the rotation changes the angle of incidence of the wind vector acting on the cargo.

5. The apparatus of claim 3, wherein the cargo platform comprises a plurality of independently rotatable cargo platforms, wherein the adjustment comprises a plurality of rotations, each corresponding to an independent rotation of one of the plurality of independently rotatable cargo platforms.

6. The apparatus of claim 5, wherein the vehicle comprises a truck with a tractor and a trailer, wherein the cargo platform is mounted on the trailer of the truck.

7. The apparatus of claim 1, wherein the adjustment to the steering parameter comprises a crabbing of a wheel of the vehicle.

8. The apparatus of claim 7, wherein the crabbing defines a lateral adjustment of an alignment of the wheel to the vehicle, wherein the alignment enables the vehicle to move at an angle relative to a longitudinal axis of the vehicle with respect to motion of the vehicle.

9. The apparatus of claim 7, wherein the crabbing comprises a crabbing angle between a heading angle in which the vehicle is pointed and a track angle in which the vehicle is traveling with respect to ground.

10. The apparatus of claim 1, wherein the adjustment to the steering parameter comprises a differential of rotational torque of a first wheel as compared to a second wheel of the vehicle.

11. The apparatus of claim 10, wherein the differential of rotational torque comprises the first wheel subject to a first driving force for rotating the first wheel and the second wheel subject to a second driving force for rotating the second wheel, wherein the first driving force is different from the second driving force.

12. The apparatus of claim 11, wherein the processor is configured to apply the first driving force to the first wheel and the second driving force to the second wheel.

13. The apparatus of claim 11, wherein the vehicle comprises a trailer coupled with a tractor, wherein the first wheel is located on a first side of the trailer and the second wheel is on a second side of the trailer opposite to the first side, wherein the first driving force of the first wheel and the second driving force of the second wheel are independently drivable.

14. The apparatus of claim 1, wherein the adjustment is based on a reduction to a drag coefficient on the vehicle from the wind condition.

15. The apparatus of claim 1, wherein the processor configured to determine the wind condition comprises processor configured to receive data from a sensor, wherein the data is indicative of a wind speed and/or an angle of incidence of the wind condition at the vehicle.

16. The apparatus of claim 1, wherein processor configured to determine the wind condition comprises the processor configured to:
receive load sensor data that is indicative of a vertical force distribution among wheels of the vehicle; and
determine the wind condition from the vertical force distribution.

17. A non-transitory, computer-readable medium comprising instructions that, when executed by one or more processors, cause the one or more processors to:
determine a wind condition acting on a vehicle that is in motion;
determine, based on the wind condition, an adjustment to a steering parameter of the vehicle or to a surface geometry of the vehicle that is exposed to the wind condition; and
control the vehicle to change the steering parameter or the surface geometry based on the adjustment.

18. The non-transitory, computer-readable medium of claim 17, wherein the adjustment to the surface geometry comprises a reshaping of the surface geometry of the vehicle to change its aerodynamic profile, wherein the reshaping of the surface geometry comprises a deformation, an extension, a retraction, or a contour adjustment of at least one surface of the vehicle exposed to the wind condition.

19. A method comprising:
determining a wind condition acting on a vehicle that is in motion;
determining, based on the wind condition, an adjustment to a steering parameter of the vehicle or to a surface geometry of the vehicle that is exposed to the wind condition; and
controlling the vehicle to change the steering parameter or the surface geometry based on the adjustment.

20. The method of claim 19, the method further comprising:
determining a predicted change in the wind condition based on a road topology; and
determining the surface geometry or steering parameter based on the predicted change.
